(19) United States
(12) Patent Application Publication
(10) Pub. No.: US 2005/0178188 A1
(43) Pub. Date: Aug. 18, 2005

(54) Flow testing system and method

(75) Inventor: Scott D. Shaw, Mesa, AZ (US)

Correspondence Address: SNELL & WILMER;ONE ARIZONA CENTER, 400 EAST VAN BUREN, PHOENIX, AZ, 850040001, US

(73) Assignee: Automated Control Systems, Inc., Gilbert, AZ (US)

(21) Appl. No.: 11/099,173

(22) Filed: Apr. 4, 2005

Related U.S. Application Data
(63) Continuation of application No. 10/600,720, filed on Jun. 20, 2003.
(60) Provisional application No. 60/390,452, filed on Jun. 21, 2002.

(51) Int. Cl. G01M 3/02

(52) U.S. Cl. 73/37

(57) ABSTRACT

A flow testing system and method are provided for facilitating the continuous flow testing of fluid flow systems and components. An exemplary flow testing system and method are suitably configured for direct implementation into the manufacturing processes for fluid flow systems and components or for stand-alone operation, and can facilitate increased flow testing throughput. An exemplary flow testing system comprises a flow amplifier subsystem, a piping subsystem, a venturi subsystem, and an output coupling subsystem. The flow amplifier subsystem is configured for coupling to an ambient air source, while the output coupling subsystem is configured for coupling to a fluid flow component for testing. The flow amplifier subsystem and venturi subsystem are configured to provide a forced air flow to facilitate the determination of whether the fluid component has any blockage or other restriction that can prevent the flow of air, and/or whether the fluid component has any leaks, thus allowing air/fluid to flow from within the fluid component to the ambient environment. In addition, the flow testing system can also be configured with a control system configured to provide control of flow testing system and/or various of the subsystems.

### CROSS-REFERENCE TO RELATED APPLICATIONS

This continuation application claims priority from currently pending U.S. patent application Ser. No. 10/600,720, entitled “Flow Testing System and Method,” filed Jun. 20, 2003, and hereby incorporated herein by reference.

### FIELD OF INVENTION

The present invention relates to fluid flow systems. More particularly, the present invention relates to a flow testing system and method that can facilitate increased throughput and/or continuous flow testing of fluid flow systems and components.

### BACKGROUND OF THE INVENTION

Present systems and methods for testing for the flow and/or leaks within fluid flow systems and components are generally limited to use in an isolated laboratory environment, as opposed to being implemented directly within the manufacturing process. One reason for this limitation is that current flow testing systems require approximately 30 seconds or more to test each fluid flow test component, and thus testing each fluid flow component is not generally feasible. Another reason is that currently available flow testing systems are rather complex and cumbersome, and thus cannot be readily installed into the production lines.

Accordingly, currently available flow testing systems are able to test fluid flow systems and components only on a random basis, as opposed to continuous testing of every fluid flow system or component that is manufactured. This random flow testing approach can only be mildly effective for identifying manufacturing equipment problems that can provide a gradual degradation in the quality of the performance of the component. Moreover, intermittent problems like plugging or other single incident defects that can occur, such as those occurring within honeycomb extrusions of various types of catalytic converters, are most often not identified by current testing systems, thus leading to higher part failures in the marketplace.

Thus a need exists for an improved flow testing system that can facilitate reduced testing cycle time and address intermittent problems occurring during the manufacture of various fluid flow systems and components.

### SUMMARY OF THE INVENTION

In accordance with various aspects of the present invention, a flow testing system and method are provided for facilitating an increased testing throughput and/or continuous flow testing of fluid flow systems and components. An exemplary flow testing system and method can be suitably configured for direct implementation into the manufacturing processes for fluid flow systems and components to facilitate testing of every fluid flow component, and/or configured for implementation as a stand-alone system, and can provide increased flow testing throughput and reduced cycle times.

In accordance with an exemplary embodiment, an exemplary flow testing system comprises a flow amplifier subsystem, a venturi subsystem, and an output coupling subsystem. The flow amplifier subsystem is configured for coupling to an air source, while the output coupling subsystem is configured for coupling to a fluid flow component for testing. The flow amplifier subsystem and venturi subsystem are configured to provide a controlled air flow that may be used to determine whether the fluid component has any blockage or other restriction that can prevent the flow of air, and/or whether the fluid component has any leaks that can allow air/fluid to flow from within the fluid component to the ambient environment. In addition, the flow testing system can also be configured with a control system configured to provide control of the flow testing system and/or various of the subsystems and components.

An exemplary method for flow testing can be configured in various manners for providing increased throughput and/or continuous testing. For example, in accordance with an exemplary embodiment, an exemplary flow testing method can comprise the steps of establishing a controlled air flow, coupling the flow testing system to the fluid component, measuring the flow within the flow testing system, and determining if a particular type of defect exists. In accordance with another exemplary embodiment, an exemplary flow testing method can comprise the steps of coupling the flow testing system to the fluid component, establishing a controlled air flow, measuring the flow within the fluid component, and determining if a particular type of defect exists. Such flow testing processes have cycle times significantly reduced from prior art testing systems, and thus can allow an exemplary flow testing system to be suitably implemented directly into the manufacturing process.

In accordance with other aspects of the present invention, the flow testing system can also be configured for self-testing prior to use with a fluid component, and can be suitably calibrated with various components having readily configurable standards and/or performance levels.

### BRIEF DESCRIPTION OF THE DRAWINGS

A more complete understanding of the present invention may be derived by referring to the detailed description and claims when considered in connection with the Figures, where like reference numbers refer to similar elements throughout the Figures, and:

FIG. 1 illustrates a block diagram of a flow testing system in accordance with an exemplary embodiment of the present invention;

FIG. 2 illustrates a block diagram of a flow testing system in accordance with another exemplary embodiment of the present invention;

FIGS. 3A-3C illustrate flow diagrams of exemplary flow testing methods in accordance with an exemplary embodiment of the present invention;

FIGS. 4A-4C illustrate cross-sectional and exploded perspective views of an exemplary flow testing system in accordance with an exemplary embodiment of the present invention;

FIGS. 5A-5C illustrate front and back exploded perspective views of an exemplary output coupling device comprising a seal nest/adapter device in accordance with an exemplary embodiment of the present invention;

FIG. 6 illustrates an exploded perspective view of a filter valve assembly in accordance with an exemplary embodiment of the present invention;

FIGS. 7A-7C illustrate end, side and perspective views of a filter valve assembly in accordance with an exemplary embodiment of the present invention;

FIG. 8 illustrates a perspective view of an exemplary flow testing system assembly in accordance with an exemplary embodiment of the present invention;

FIG. 9 illustrates an exploded perspective view of an exemplary output coupling device comprising a dual gripper/end cap assembly in accordance with an exemplary embodiment of the present invention;

FIG. 10 illustrates a cross-sectional view of an exemplary flow testing system in accordance with another exemplary embodiment of the present invention;

FIG. 11 illustrates a side view of an exemplary flow testing system in accordance with another exemplary embodiment of the present invention;

FIG. 12 illustrates a top view of an exemplary dual flow testing system in accordance with another exemplary embodiment of the present invention;

FIGS. 13A-13D illustrate perspective, top and side views of an dual exemplary flow testing system assembly in accordance with another exemplary embodiment of the present invention;

FIG. 14 illustrates a side view of an exemplary flow testing system assembly in accordance with another exemplary embodiment of the present invention;

FIG. 15 illustrates a perspective view of an exemplary flow testing system in accordance with another exemplary embodiment of the present invention; and

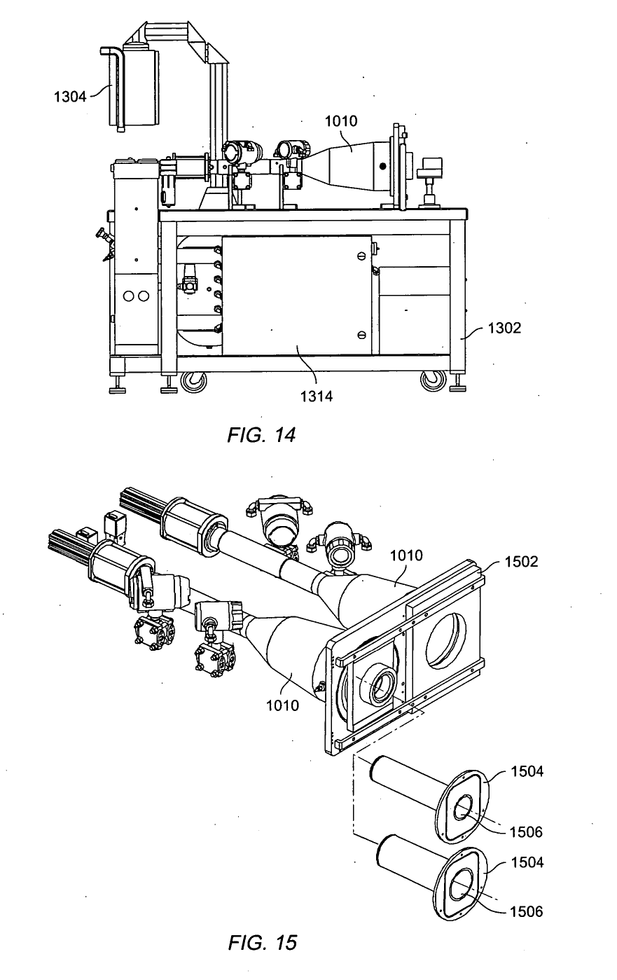

FIG. 16 illustrates a front view of an exemplary output coupling device comprising a seal nest/adapter device in accordance with another exemplary embodiment of the present invention.

### DETAILED DESCRIPTION

The present invention is described herein in terms of various hardware components and testing steps. It should be appreciated that such components may be realized by any number of hardware components configured to perform the specified functions. For example, in its various embodiments the present invention may include various pneumatic, hydraulic, mechanical, and electronic components, e.g., pressure sensors, filters, cylinders, valves, pumps, amplifiers, signal processing elements, solenoids, limit switches and the like, which may carry out a variety of functions either directly or under the control of one or more microprocessors, programmable logic controllers or other control devices. In addition, the present invention may be practiced in any number of fluid contexts and the illustrative embodiment described herein is merely one exemplary application for the invention. Further, the various subsystems, components and devices may be suitably coupled directly to other subsystems, components and devices, or coupled through various other devices and components, such as regulators, filters and/or other flow devices, electrical signals, and/or mechanical linkages to other subsystems, components and devices.

As discussed above, prior art flow testing systems are limited in flow testing throughput, generally being specifically configured only for random testing, such as within a laboratory environment. However, in accordance with various aspects of the present invention, a flow testing system and method are provided for facilitating increased throughput and/or continuous flow testing of fluid flow systems and components. An exemplary flow testing system and method are suitably configured for direct implementation into the manufacturing processes of fluid flow systems and components, and/or for implementation as a stand-alone system, and can facilitate increased flow testing throughput. As a result, more effective flow testing of fluid flow systems and components can be provided to minimize the problems caused by random part testing.

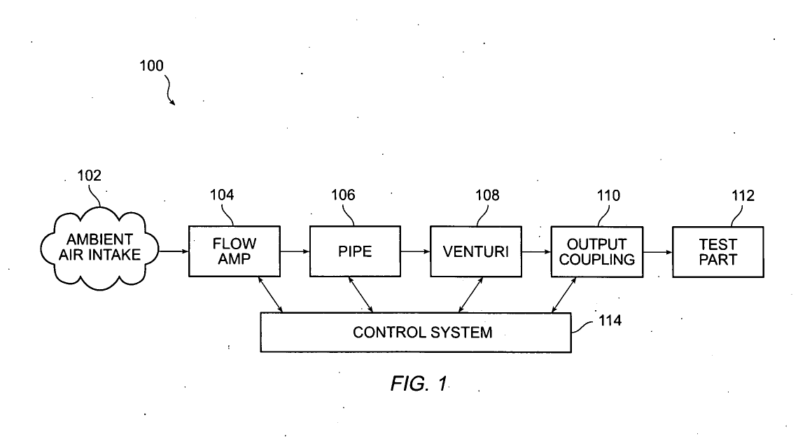

In accordance with an exemplary embodiment, with reference to FIG. 1, an exemplary flow testing system 100 comprises a flow amplifier subsystem 104, a venturi subsystem 108, and an output coupling subsystem 110. Flow testing system 100 is configured for coupling to an air intake source 102 to provide flow testing of a fluid component test 112.

Air intake source 102 can comprise any air intake source, e.g., ambient air, compressed air or the like. In addition, rather than ambient air and/or compressed air, an intake source 102 can suitably comprise other gases, e.g., nitrogen, oxygen or other non-toxic gases, as well as various fluids, e.g., water, alcohol or any other fluid capable of flowing within flow test system 100. Fluid component 112 can comprise various types of fluid flow components, devices or parts, e.g., a honeycomb extrusion of a catalytic converter, or various filters and exhausts, or any other component or device configured for providing fluid flow, such as air, liquid, or gas. Fluid component 112 can also comprise any other component or device configured for providing a air/gas/liquid tight seal, such as containers, tanks, piping structures and the like. In addition, flow testing system 100 can be suitably controlled by various types of control systems configured internally or externally with flow testing system 100. For example, flow testing system 100 can also suitably include, or be configured with, a control system 114.

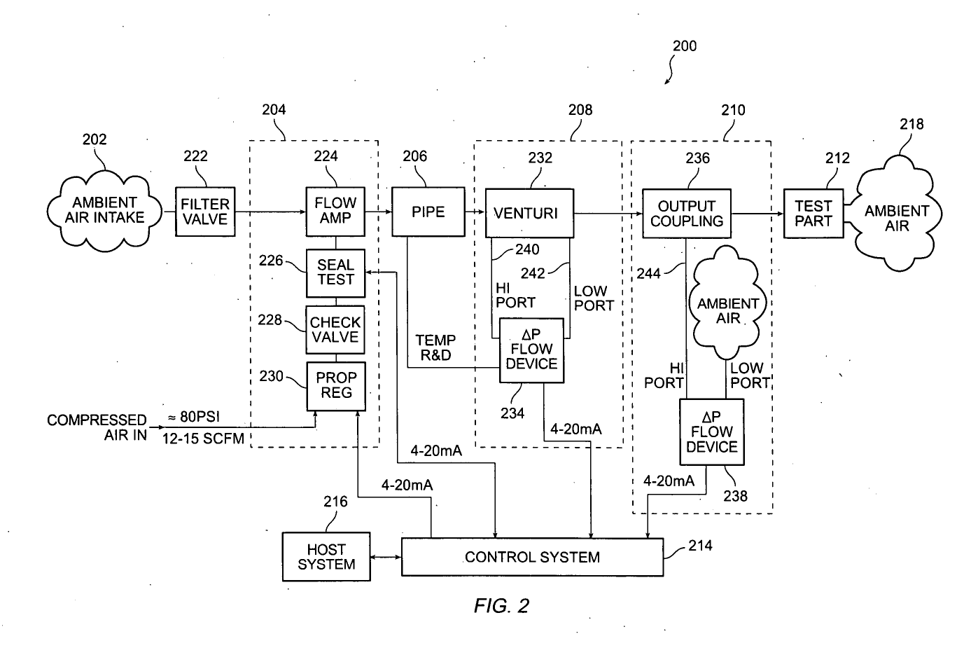

Flow amplifier subsystem 104 is configured for providing a controlled air flow to other devices. Flow amplifier subsystem 104 is configured for coupling to air intake 102 and for coupling to venturi subsystem 108. Flow amplifier subsystem 104 can be directly coupled to air intake 102, or through various filter, regulator and/or other fluid flow devices and components. For example, with momentary reference to FIG. 2, flow amplifier subsystem 104 can be directly coupled to air intake 102 through a filter and/or through a filter valve 222.

In accordance with the exemplary embodiment, flow amplifier subsystem 104 is configured to receive air from air source 102, e.g., from an air source of approximately 90 PSI and approximately 5-40 SCFM. Air source 102 can comprise compressed air or any other air/gas or other fluid supply configuration, and can include various other pressure levels greater than or less than 90 PSI, and flow levels of greater than or less than 5-40 SCFM.

Flow amplifier subsystem 104 is also configured to convert the air received from air intake 102 to a controlled air flow, e.g., to approximately 2 PSI or less and approximately 100-650 SCFM, to be provided to venturi subsystem 108. Various other pressure and flow levels can also be provided by flow amplifier subsystem 104, such as less than 50 SCFM and greater than 2500 SCFM depending on the particular application and the size and type of fluid component 112.

For conversion of airflow, in accordance with an exemplary embodiment, flow amplifier subsystem 104 can comprise a small orifice, crack, crevice or other opening to allow intake air to be forced through, which results in a pressure drop. For example, flow amplifier subsystem 104 can comprise an air chamber having an input port coupled to an air source, e.g., compressed air or other gases of approximately 90 PSI and approximately 5-40 SCFM, that is configured to provide forced air into the chamber and through a small orifice or other opening within flow amplifier subsystem 104. However, flow amplifier subsystem 104 can comprise any other configuration of flow amplifier devices now known or hereinafter devise that is configured to provide a controlled air flow to other devices. In addition, flow amplifier subsystem 104 can include various other couplings or connections configured for coupling to other testing, regulator or flow devices to provide other functions.

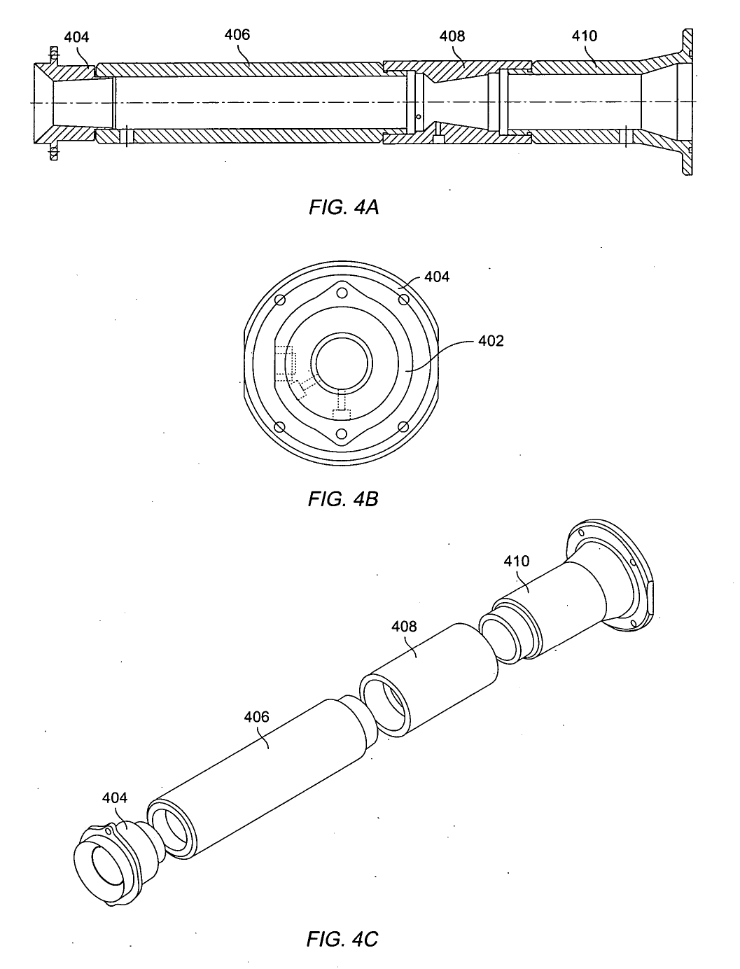

For example, with additional reference to FIGS. 4A-4C, a cross-sectional, front and exploded perspective view of an exemplary flow testing system assembly 400 are illustrated. A flow amplifier subsystem 104 can comprise a flow amplifier 404 having a flanged end 402 configured for coupling to an ambient or compressed air source, such as through a filter valve 222, or directly to an air intake source. In addition, flow amplifier 404 can comprise an inner rimmed member 406 that can be coupled to other flow testing system components through various mechanisms, such as through use of a sealant or other adhesive, or through threaded, clamped or other mechanical mechanisms. In addition, flow amplifier 404 can also be configured with national pipe thread (NPT), male thread, female thread, and/or other like connections for coupling to other devices for providing measurements of flow, temperature or other parameters, such as for facilitating seal testing of flow testing system 100, as described in more detail below. In accordance with this exemplary embodiment, flow amplifier 404 comprises a high-pressure air chamber 404A having an input port 404B configured for coupling to an air source, e.g., a compressed air or other gases of approximately 90 PSI and approximately 5-40 SCFM. The air source can provide a forced air through input port 404B and chamber and through a small orifice 404C. Flow amplifier 404 can also provide a concave-like surface 404D within the inner perimeter, proximate to an ambient air source and/or a filter, and configured with orifice 404C to draw additional ambient air from intake source 102. In other words, air is forced through orifice 404C to interact with surface 404D and cause a drawing effect to pull additional ambient air through flow amplifier 404 to establish a controlled air flow.

Venturi subsystem 108 can be configured in various manners for facilitating the determination of air flow within flow testing subsystem 100. For example, venturi subsystem 108 is configured to enable the detecting of changes in fluid pressure between an entry section and an exit section, thus enabling fluid flow calculations within venturi subsystem 108 to be made. In accordance with an exemplary embodiment, venturi subsystem 108 can include a pair of output ports, e.g., a first output port configured at an entry section for measuring pressure upstream of the air flow within venturi subsystem 108, and a second output port configured at an exit section for measuring pressure downstream of the air flow within venturi subsystem 108. Through the measuring of the pressure between the first output port and the second output port, the difference in pressure between entry and exist sections can be determined, thus allowing flow calculations to be made.

With momentary reference again to FIG. 2, in accordance with an exemplary embodiment, a venturi subsystem 208 can comprise a venturi 232 and a pressure difference (ΔP) flow device 234. Venturi 232 is configured to provide a pressure drop for facilitating the measuring of fluid flow, e.g., by providing increased velocity and decreased pressure at an exit section from an entry section. Venturi 232 comprises an entry (higher-pressure) output port 240 and an exit (lower pressure) output port 242 configured for coupling through to pressure difference (ΔP) flow device 234.

Venturi 232 can comprise any type of device configured to provide a restricted opening that can increase velocity and decrease pressure, i.e., any device that provide a pressure drop for measuring fluid flow. For example, with momentary reference to FIG. 4, a venturi 408 can comprise a narrow entry section and a wider exit section to provide a pressure drop. In addition to various types of venturi-like configurations, venturi 232 can also comprise a restrictor plate having an opening or hole through the plate that can allow for a pressure drop. Further, venturi 232 can also comprise an orifice plate or a sonic nozzle configured for generating a decrease in pressure to provide a pressure change from an entry section to an exit section and thus enable flow calculations. Accordingly, venturi 232 can comprise any configuration for providing a pressure drop to facilitate flow measurement calculations.

Pressure difference (ΔP) flow device 234 is configured to determine differences in pressure between the entry, higher-pressure section of venturi 232 and the exit, lower pressure section, i.e. the amount of pressure drop. For example, pressure difference (ΔP) flow device 234 can be configured to determine the pressure difference between high output port 240 and low output port 242 of venturi 232. With the pressure difference between ports 240 and 242 determined, flow calculations within venturi 232 can be suitably made, for example within a control system 214 and/or host system 216, through conventional ΔP/flow calculation methodologies.

Pressure difference (ΔP) flow device 234 can comprise any device or system for measuring pressure and determining difference in pressure between two output ports, now known or hereinafter devised. Pressure change (ΔP) flow device 234 can be configured to calculate differences in pressure, or for providing a signal indicative of the differences in pressure to control system 214, e.g., 4-20 mA or other analog, RF or digital signals.

In addition to using the pressure differences between ports 240 and 242 to calculate simple flow measurements, in accordance with another exemplary embodiment, ΔP flow device 234 can also be configured with a resistance temperature detector (RTD) signal, barometric pressure indicative signals, or other like output signal for more accurate and/or detailed mass-flow calculations. For example, such signals can enable ΔP flow device 234 to make temperature compensation adjustments and/or sense and compensate for barometric pressure to facilitate true mass-flow calculations in determining flow measurements within flow testing system 200.

With venturi subsystem 108 be suitably configured to provide flow calculations, venturi subsystem 108 can provide a controlled feedback loop to facilitate a controlled air flow within flow amplifier 104. For example, as flow amplifier subsystem 104 receives air from air source 102, flow amplifier 104 converts the air received to a controlled air flow that can be suitably measured by venturi subsystem 108. Thus, if a controlled air flow level is desired, for example, approximately 2 PSI and approximately 175 SCFM, venturi subsystem 108 can facilitate a determination of whether additional or less air flow is needed within flow amplifier subsystem 104, and thus allow flow testing system 100 to suitably adjust the air intake source to be provided to flow amplifier subsystem 104.

Venturi subsystem 108 is configured for coupling to flow amplifier subsystem 104 through various arrangements. In accordance with an exemplary embodiment, venturi subsystem 108 can be configured for coupling to flow amplifier subsystem 104 through a piping subsystem 106; however, venturi subsystem 108 can also be configured for direct coupling to flow amplifier subsystem 104, i.e., without piping subsystem 106, or coupled through other arrangements. Venturi subsystem 108 is further configured for coupling to a fluid component 112, such as a catalytic converter or any other type of fluid flow device, through output coupling subsystem 110.

In accordance with an exemplary embodiment, flow testing system 100 also includes a piping subsystem 106 comprising a passageway configured for coupling flow amplifier subsystem 104 to venturi subsystem 108, and can comprise various types of piping and/or tubing, and various sizes. Piping subsystem 106 can be coupled to flow amplifier subsystem 104 and to venturi subsystem 108 through various manners, including male or female connectors, threaded or compression fit, and/or sealed with adhesive. In accordance with an exemplary embodiment, piping subsystem 106 can also be configured with NPT or other like connections for providing measurements of flow, temperature or other parameters. For example, piping system 106 can be configured to provide temperature and/or barometric-pressure related signals to enable mass-flow calculations. While piping subsystem 106 can be suitably configured as a separate component between flow amplifier subsystem 104 to venturi subsystem 108, for example as illustrated with momentary reference to a piping subsystem 406 in FIG. 4, or directly configured within one or both of flow amplifier subsystem 104 and venturi subsystem 108.

With reference again to FIG. 1, output coupling subsystem 110 is configured to provide a fluid passageway to couple venturi subsystem 108 to fluid component 112 for flow testing. Output coupling subsystem 110 can comprise a piping section, a flange, a seal nest and/or other types of connection and coupling devices to couple flow testing system 100 to fluid component 112. Output coupling subsystem 110 can comprise a separate component apart from venturi subsystem 108, or can comprise a sub-component of, or otherwise be configured within, venturi subsystem 108. Output coupling subsystem 110 can also be configured in various shapes having various dimensions for providing a fluid passageway between venturi subsystem 108 to fluid component 112.

For example, with momentary additional reference again to FIGS. 4A-4C, in accordance with an exemplary embodiment, an output coupling subsystem 110 can comprise an output coupling 410 having a male connector 412 configured for coupling to a female connector coupling of venturi 408, and a flanged end 404 for coupling to a fluid component 112. Male connector 412 can comprise any connector configuration. For example, output coupling 410 can include a female connector, rather than a male connector, for coupling to a male connector of venturi 408, or any other connector configuration for coupling to venturi 408. In addition, output coupling 410 can be configured in a compression fitted, bolted, threaded or any arrangement for coupling to venturi 408.

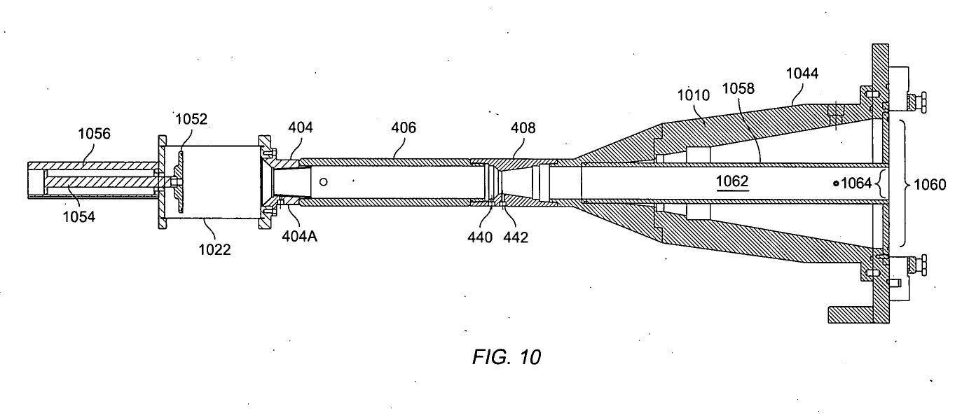

Output coupling 410 can comprise a passageway having various sizes and shapes, depending on the size and shape of fluid components tested. In addition, output coupling 410 can be configured to provide a passageway that can be suitably modified in size or dimension so that output coupling 410 can provide testing of various sizes and dimensions of fluid components. For example, with momentary reference to FIG. 10, an output coupling 1010 can comprise an insert tube 1058 defining a passage way 1062 and having an opening 1064 that is smaller than an opening 106o without insert tube 1058. The amount of opening 1064 of insert tube 1058 can be suitably configured in various sizes to adapt to different fluid components. Thus, for example, for larger fluid components, output coupling 1010 can be used without insert tube 1058, while for smaller fluid components, a suitably sized insert tube 1058 can be utilized.

Output coupling 410 can be configured in various manners for coupling to a fluid component. For example, output coupling 410 can comprise a flanged end 414 configured for coupling to a fluid component, or another coupling component. Flanged end 414 can be configured at various widths and sizes depending on the type and configuration of fluid component. In addition, flanged end 414 can be suitably configured in a compression fitted, bolted, threaded or any arrangement for coupling to a fluid component.

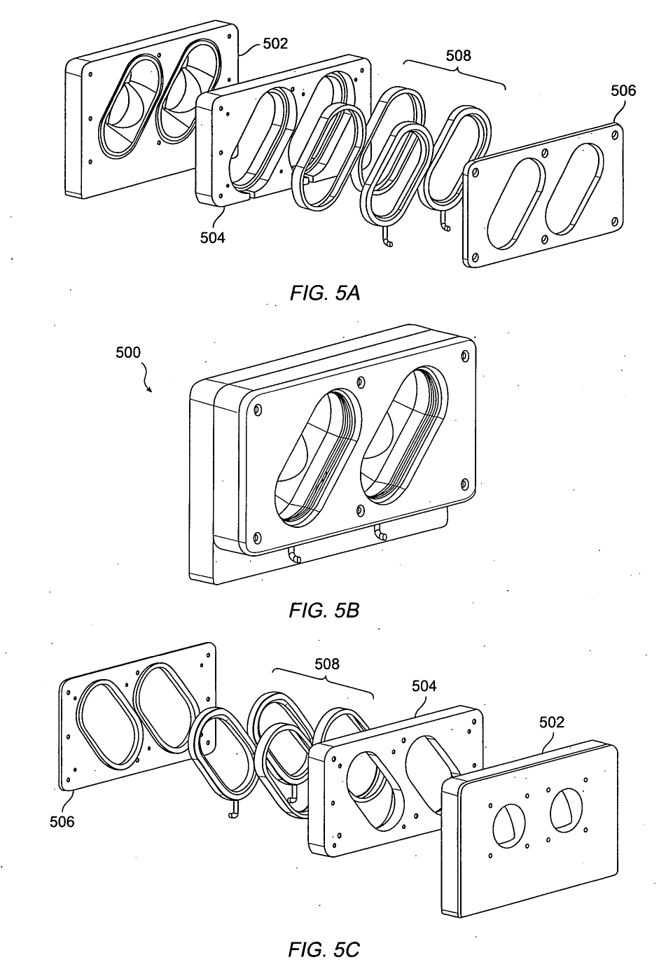

In accordance with an exemplary embodiment, output coupling subsystem 110 can be coupled to a fluid component 112 through use of a coupling component. For example, in accordance with one exemplary embodiment, with momentary additional reference to FIGS. 5A-5C, output coupling subsystem 110 can comprise a coupling component comprising a seal nest 500 including a series of adapter plates 502, 504 and 506 and sealing rings 508, which are readily adaptable to venturi subsystem 108 through a flanged member of output coupling subsystem 110. The sealing rings can be configured to not only provide a seal around fluid component 112 when nestled within, but also to grip fluid component 112 to prevent movement. The coupling component can comprise any other configuration for coupling output coupling 410 to fluid component 112. For example, while a seal nest 500 is configured for two fluid components, a coupling component can be configured to hold/grip fewer or additional fluid components.

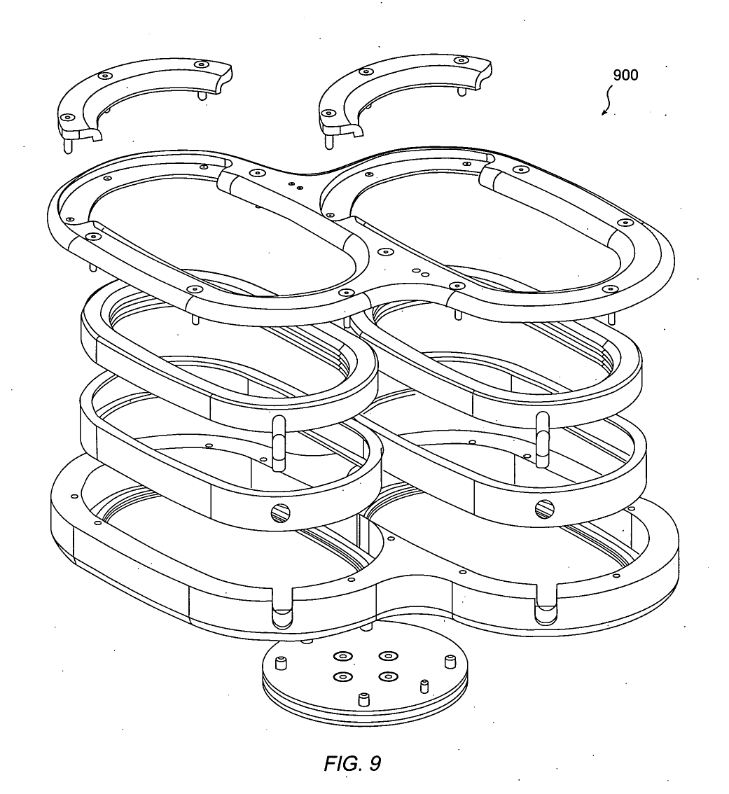

Output coupling subsystem 110 can also be suitably coupled to fluid component 112 through various methods, such as through use of robotics-type arms or other automated positioning systems, or through manual positioning or coupling of fluid component 112 to output coupling subsystem 110. For example, with reference to an exemplary embodiment illustrated in FIG. 9, a dual gripper device 900 can be configured for picking up and/or moving component test parts 112 as desired for testing. Dual gripper 900 can include one or more sealing rings that can suitably expand to provide a firm grip on fluid components 112 during transportation from a conveyor or manufacturing line to interface with output coupling subsystem 110. While dual gripper device 900 illustrates a gripper configured for gripping a pair of catalytic converter devices, dual gripper device 900 can include various other orientations and shapes for coupling one or more other types of test components 112 to flow testing system 100. For example, a single or triple gripper device or more can be provided. In addition, gripper device 900 can be configured as a part of or otherwise with a robot device for automatic coupling of fluid components to output coupling subsystem 110, or for simply configured manual coupling.

In addition to coupling to fluid component 112, output coupling subsystem 110 is also configured for facilitating flow calculations in fluid component 112. In accordance with an exemplary embodiment, with reference to FIG. 2, an output coupling subsystem 210 can comprise an output coupling device 236 configured with a pressure difference (ΔP) flow device 238. Output coupling device 236 can comprise various configurations, such as output coupling 410 and/or 1010. Output coupling 236 can comprise an output port 244 configured to provide a pressure measurement from an entry side of a fluid component 212. However, a pressure measurement from an entry side of fluid component 212 could also be realized through output port 242, i.e., the exit port of venturi 232.

Pressure difference (ΔP) flow device 238 has an input port coupled to output port 244, or to output port 242, and includes a second input port for coupling to an exit side of fluid component 212. For example, the second input port can be coupled to ambient air, e.g., through a filter or other like device, or through a second venturi-like device coupled to an exit side of fluid flow component 212 to allow measurement of pressure differences at the output of fluid flow component 212 and facilitate output flow calculations. Pressure difference (ΔP) flow device 238 is configured to measure the pressure at the entry side of fluid component 212, e.g., within output coupling 236, and to measure the pressure at the exit side of fluid component 212, e.g., the ambient or barometric pressure. Once the differences in pressure ΔP are determined, flow calculations across fluid component 112 can be determined, e.g., by pressure difference (ΔP) flow device 238, or through a signal provided from pressure difference (ΔP) flow device 238 to control system 214.

As discussed above, flow testing system 100 can also be suitably controlled by one or more micro-processor or other computer control systems. For example, flow testing system 100 can suitably include or be configured with control system 114 for controlling operation of flow testing system 100. In accordance with an exemplary embodiment, control system 114 suitably comprises any type of control system for controlling multiple devices and components. Control system 114 can comprise any microprocessor based system, such as PC-based or PLC-type devices, and can include one or more displays and/or user interfaces. Control system 114 can be coupled to any one or all of flow amplifier subsystem 104, venturi subsystem 108, and output coupling subsystem 110 to control operation of flow testing system 100. Control system 114 can be configured to receive various input signals and provide various output signals, e.g., analog, radio frequency or digital signals, or other discrete output signals. For example, control system can be configured to receive and transmit 4-20 mA signals, discrete signals, and/or serial communications and the like to and from the various components. In accordance with an exemplary embodiment, with momentary reference to FIG. 2, a control system 214 can be coupled to a host PC system 216, or can be directly controlled by a system user.

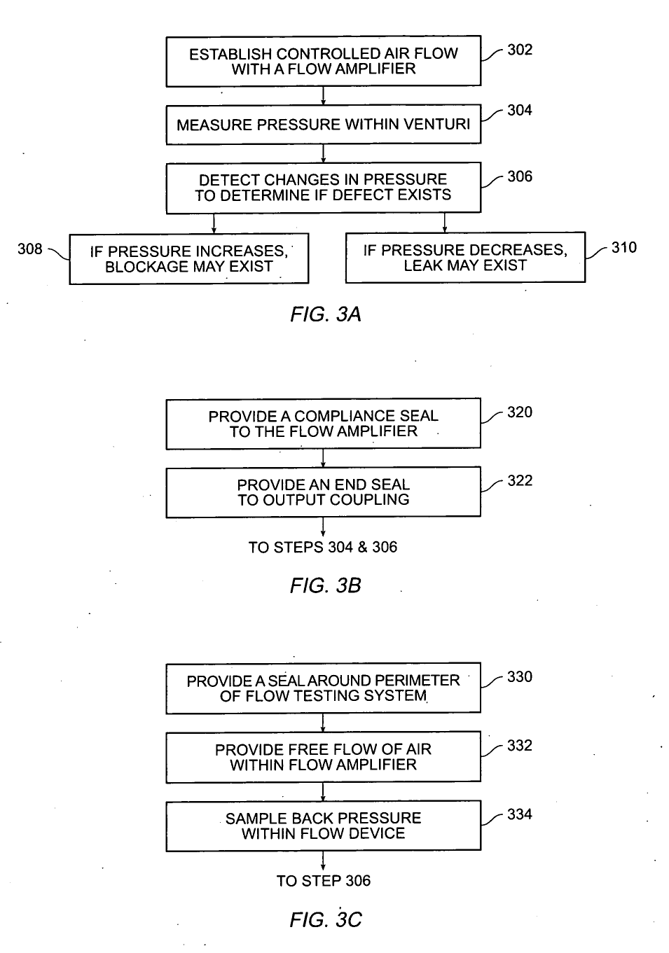

Having described various exemplary embodiments of flow testing system 100, an exemplary method for flow testing can be provided in various manners for detecting defects in a fluid flow component 112, such as any blockages that restrict air flow, e.g., any cell blockages in a catalytic converter, and/or whether fluid component 112, or flow testing system 100 itself, has any leaks allowing air to flow through to ambient air. For example, in accordance with an exemplary embodiment, with additional reference to FIG. 3A, as well as FIGS. 2 and 4, an exemplary flow testing method can comprise a step 302 of establishing a controlled air flow within flow amplifier subsystem 104 and venturi subsystem 108. For example, air, gas for other fluid can be suitably forced through flow amplifier 104, such as through a chamber 404A and drawn through an opening to flow amplifier 404. The incoming air flow can be suitably increased to provide a flow level that can be suitably calculated by venturi subsystem 108, e.g., by measuring pressure at the entry and exit sections of a venturi 208 and then calculating flow, or mass-flow if barometric/temperature signals are utilized. With a control loop provided through venturi subsystem 108, the incoming air flow can then be adjusted to a desired controlled air flow. Once a controlled air flow is established, flow testing system 100 can be coupled to the fluid component 112 in a step 304, e.g., through output coupling subsystem 110 and/or various other coupling components.

In a step 306, once flow test system 100 is coupled to fluid component 112, the air flow within flow testing system 100 can be suitably determined, e.g., by determining flow within venturi subsystem 108, or within other components of flow testing system 100, such as the flow within output coupling system 110. Once flow is again measured, flow testing system 100 can determine in a step 308 whether a defect exists, and/or the amount and/or significance of the defect. For example, if the difference in pressure within venturi subsystem 108 decreases, or the calculated flow within flow testing system 100 decreases, a blockage condition may exist.

While the method illustrated in FIG. 3A can provide for suitable flow testing of fluid components, other methods can be provided for more precise indications of a defect, such as the amount of blockage in a fluid component. For example, with reference to FIG. 3B, in accordance with another exemplary embodiment, an exemplary flow testing method can comprise the step 310 of coupling flow testing system 100 to fluid component 112, such as through the manners described above in step 304. Once flow testing system 100 is coupled to fluid component 112, a controlled air flow can be established in a step 312, such as through the various manners utilized in step 302. Once the controlled air flow is established, the air flow within the fluid component can be suitably measured in a step 314. For example, the pressure at the entry side of fluid component, e.g., within output coupling 110, can be suitably measured and compared to the pressure at the exit side of fluid component 112, e.g., the barometric pressure, thus enabling flow calculations within fluid component 112 to be suitably made.

Once the flow calculation within fluid component is made, flow testing system 100 can determine in a step 316 whether a defect exists within fluid component 112. This determination can be made in various manners. For example, in accordance with an exemplary embodiment, flow testing system 100 can compare the flow within fluid component 112 to the controlled air flow within flow amplifier subsystem 104, and/or can monitor the pressure at various locations to identify changes in pressure.

In accordance with another exemplary embodiment, flow testing system 100 can compare the flow within fluid component 112 to a baseline or ideal flow rate for such fluid components 112. The baseline flow rate can be suitably defined in various manners. For example, in accordance with an exemplary embodiment, calibration fluid components can be provided to one with a substantially blockage-free configuration, and one with an unacceptable level of blockage. The calibration fluid components can be suitably tested within flow testing system 100 to develop one or more baseline levels for flow calculations or pressure differences measured, e.g., by a flow device 238, to facilitate comparisons to other fluid components. In addition, fewer or more calibration components can be realized, such as only a substantially blockage-free component, a heavily block component, or one or more blockage levels in between. Moreover, with two or more calibration components, a calibration curve can be generated so that testing of fluid components can result in an indication of the specific amount of blockage or other defect that has been identified.

Either of flow testing methods illustrated in FIG. 3A or 3B can include simple flow calculations, or include more precise mass-flow calculations, such as through the use of temperature/barometric pressure signals. In addition, either of flow testing methods can be suitably combined or utilized for various types of fluid components. Still further, in addition to increased accuracy, such flow testing processes can occur in approximately 10 seconds or less, often in as little as 3 seconds. As a result, a significantly reduced cycle time from prior art testing systems is provided, and thus can allow an exemplary flow testing system and method to be suitably implemented directly into the manufacturing process.

In accordance with another aspect of the present invention, flow testing system 100 can be configured for self-testing prior to, or after, testing of fluid component 112 to ensure that flow testing system 100 is properly operating. For example, with reference to an exemplary embodiment of a flow testing system 200 illustrated in FIG. 2, flow amplifier subsystem 204 can comprise a flow amplifier 224, a seal test device 226, a check valve 228, and a proportional regulator 230.

Seal test device 226 is configured at the end opposite component test part 112 to provide a compliance seal for flow amplifier subsystem 204. During operation, seal test device 226 is configured to operate at a low pressure, e.g., approximately 2-4 PSI, that represents only the amount of pressure needed for self-testing; however, seal test device 226 can suitably operate at higher pressures. Seal test device 226 can receive and provide signals to and from a control system 214 for controlling the sealing process, such as 4-20 mA signals. Seal test device 226 can comprise various sizes, shapes and configurations. While seal test device 226 can comprise a separate component, as is described in more detail below, seal test device 226 can also be suitably configured within filter valve 222. Check valve 228 is configured between seal test device 226 and proportional regulator 230 to prevent air from flowing from seal test device 226 back through to proportional regulator 230. Check valve 228 can comprise any conventional type of check valve. Proportional regulator 230 is configured to regulate the operation of seal test device 226. Proportional regulator 230 is configured to receive compressed air, e.g., 0-120 PSI at 0-200 SCFM, and can be controlled through an input control signal, e.g., 4-20 mA, from control system 114. Proportional regulator 230 can also be configured to provide forced air into flow amplifier 224, such as through chamber 404A of flow amplifier 404.

To complete a seal around flow testing system 200, or to a component test part 212, output coupling subsystem 210 can be configured with an end cap configuration. An end cap can be suitably coupled to an output coupling in any manner to provide a seal to prevent air from flowing out of output coupling 210. For example, with momentary reference to an exemplary embodiment illustrated in FIG. 9, a dual gripper device 900 can be configured for providing an end cap or closure to the component testing end of flow testing system 200 to facilitate the sealing process. However, output coupling subsystem 110 can comprise any other configuration for providing an end cap to facilitating sealing.

With reference to FIG. 3C, an exemplary self-testing method comprises a step 318 of providing a seal to flow testing system 200, such as by providing a compliance seal to flow amplifier 224, and completing a seal at output coupling 210. Next, in a step 320, a fluid pressure is provided to flow amplifier 224 to provide an initial pressure within flow testing system 200. Once a fluid pressure is provided, a step 322 can determine if any pressure changes occur that may be indicative of a leak. For example, any decrease in pressure measured within venturi subsystem 208, and/or within or proximate to flow amplifier subsystem 204, can be indicative of a leak or other like defect within flow testing system 200. In addition, measurements of pressure can be taken to provide flow calculations to determine whether air is flowing, i.e., flowing or leaking out of flow testing system 100.

The self-testing process of FIG. 3C can also be suitably utilized to test for leaks in various containers, tanks, piping and the like. For example, rather than providing a seal at output coupling 210 through an end cap configuration, a container, tank or other device to be testing for leaking can be suitably coupled to output coupling 210. Accordingly, once a fluid pressure is provided, any pressure changes can be monitored to determine is leaks are present.

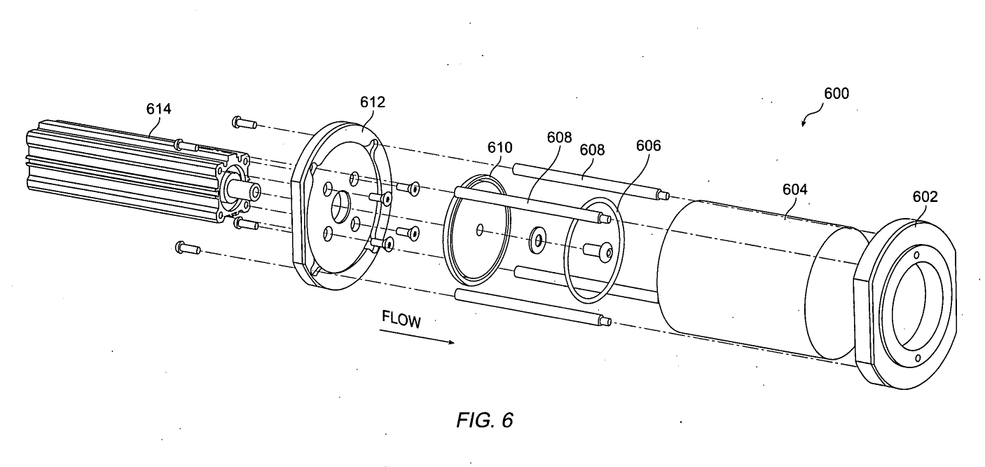

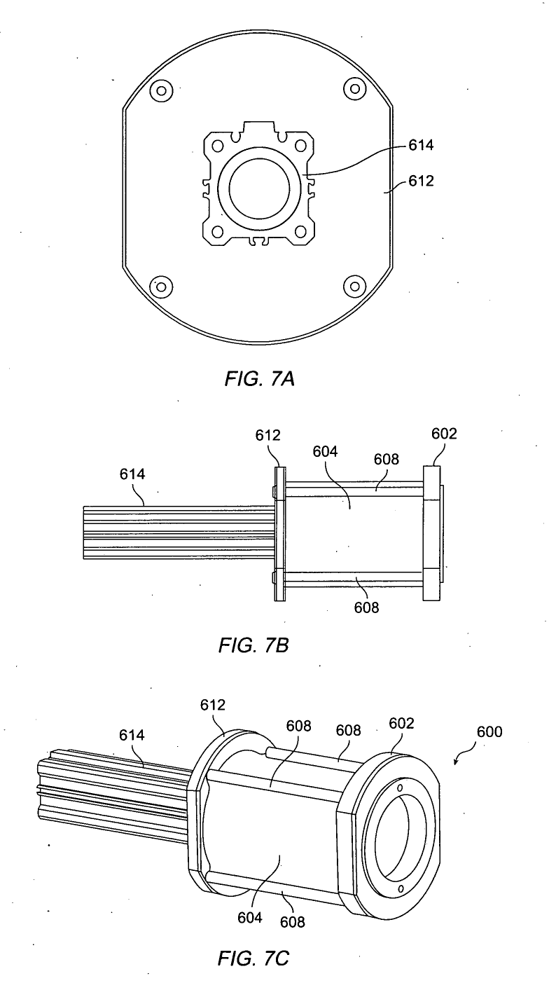

As discussed above, filter valve 222 can be configured to simply filter ambient air intake 102. However, in accordance with another exemplary embodiment, filter valve 222 can also provide a seal to flow testing system 200 during the self-testing process, i.e., filter valve 222 can be configured to suitably replace seal test device 226. Filter valve 222 can also comprise various structures and types. In accordance with an exemplary embodiment, with reference to FIGS. 6 and 7A-7C, a filter valve 600 can comprise an end cap 602, a filter screen 604, an O-ring 606, a plurality of rods 608, a housing plate 610, a cap cylinder support 612, and a cylinder housing 614. Filter valve 600 is configured to enhance laminar flow of flow testing system 200.

With reference again to FIG. 10, a filter valve 1022 can comprise a cylinder 1054 configured within a housing 1056 and coupled to a closure plate 1052 to provide a seal to the air intake of flow amplifier 404. Cylinder 1054 can be single or double-actuated, and can be suitably operated by various actuators configurations, such as pneumatic, hydraulic, electrostatic or any other actuator mechanism. Thus, while a flow amplifier 404 can be suitably coupled to a separate filter and a separate seal test device 226, filter valve 222 can suitably provide both functions.

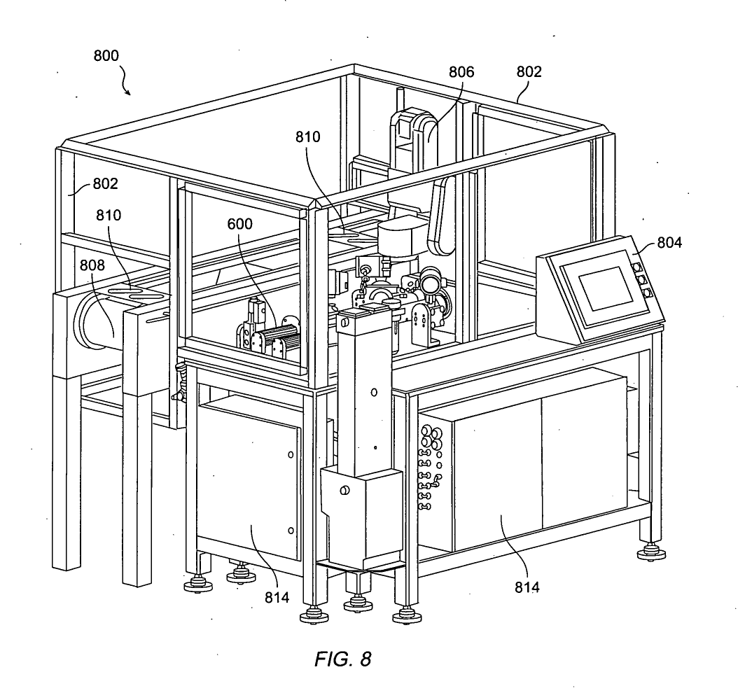

Having described various exemplary embodiments of the components of flow testing system 200, an exemplary flow testing system assembly 800 for implementation directly into the manufacturing process, or for operation as a stand-alone system, is illustrated in FIG. 8. In accordance with this exemplary embodiment, flow testing system 800 is configured for testing two test components at a time, e.g., two catalytic converter, such as through use of a dual gripper 400 and dual seal nest 500; however, fewer or more components can also be tested in accordance with other exemplary embodiments.

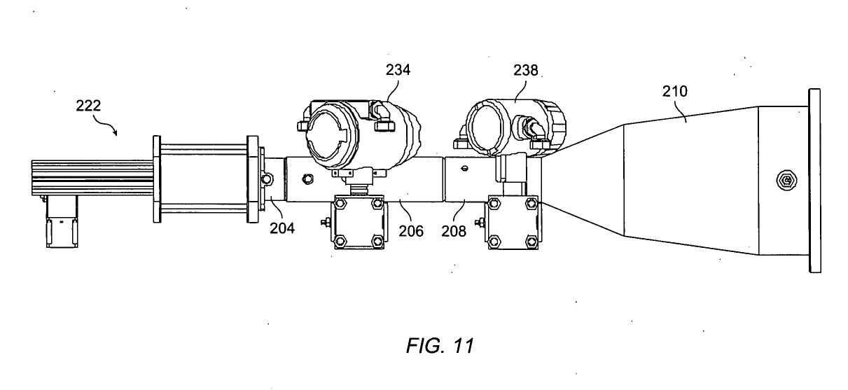

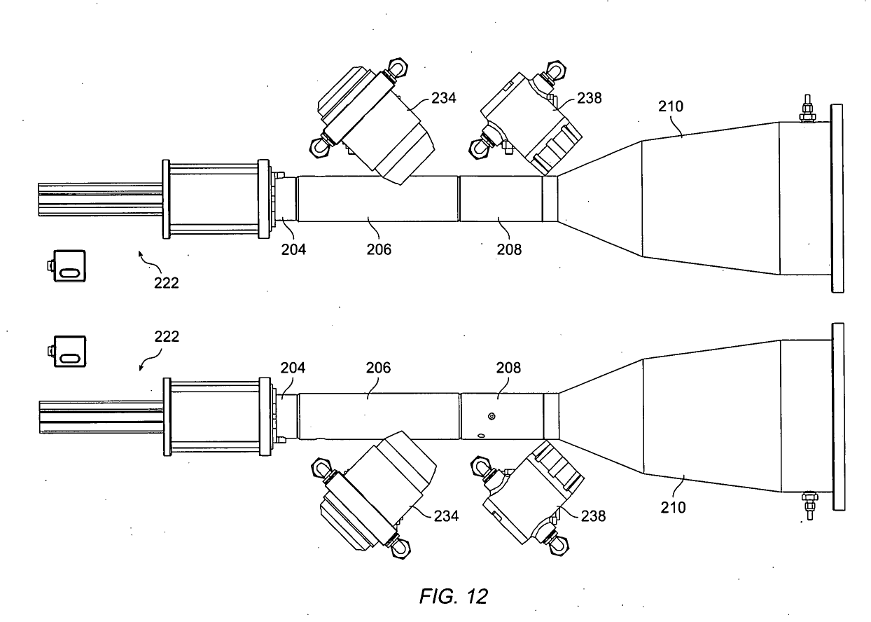

The various subsystems and components can be suitably coupled together in various manners on an exemplary flow testing assembly. For example, in accordance with an exemplary embodiment, with reference to FIG. 11, an exemplary flow testing system can comprise filter valve 222, flow amplifier 222, piping section 206, venturi 208, and output coupling 210 consecutively coupled together, with pressure change (ΔP) flow devices 234 and 238 suitably mounted proximate to venturi 208 and output coupling 210. In addition, flow testing system assembly can be configured with dual flow testing systems, such as is illustrated with reference to FIG. 12.

In addition to the components of flow testing system 200, e.g., filter valve 222, flow amplifier subsystem 204, piping subsystem 206, venturi subsystem 208 and output coupling subsystem 210, an exemplary flow testing system 800 can also comprise a housing frame 802, a display 804, a robot 806, a conveyor system 808, and a control system 814. Housing frame 802 is configured to support the various components and devices of flow testing system 800, and can comprise various types of frame members of varying thicknesses and alloys or materials. Display 804 can comprise any type of display and is configured to provide a user interface for control of flow testing system 800.

Conveyor system 808 is configured to provide for the conveying of fluid components, e.g., two catalytic converters, from an assembly or manufacturing line to be tested by flow testing system 800. Conveyor system 808 can also be configured and arranged in various manners. In the exemplary embodiment, conveyor system 808 can include one or more transport members 810 configured to hold the fluid components during travel on conveyor system 808. To provide for automated transport of fluid components from transport members 810 of conveyor system 808, robot 806 can be configured to grip, such as through use of dual gripper 400, the fluid components and place the fluid components within seal nest 500. Accordingly, flow testing system 800 can be suitably incorporated directly into the production line for the fluid components, thus enabling real-time testing for each fluid component without additional delay to the manufacturing process. In addition, an exemplary flow testing system assembly can also be configured without automatic or robotics operation, but rather through manual coupling of one or more fluid components.

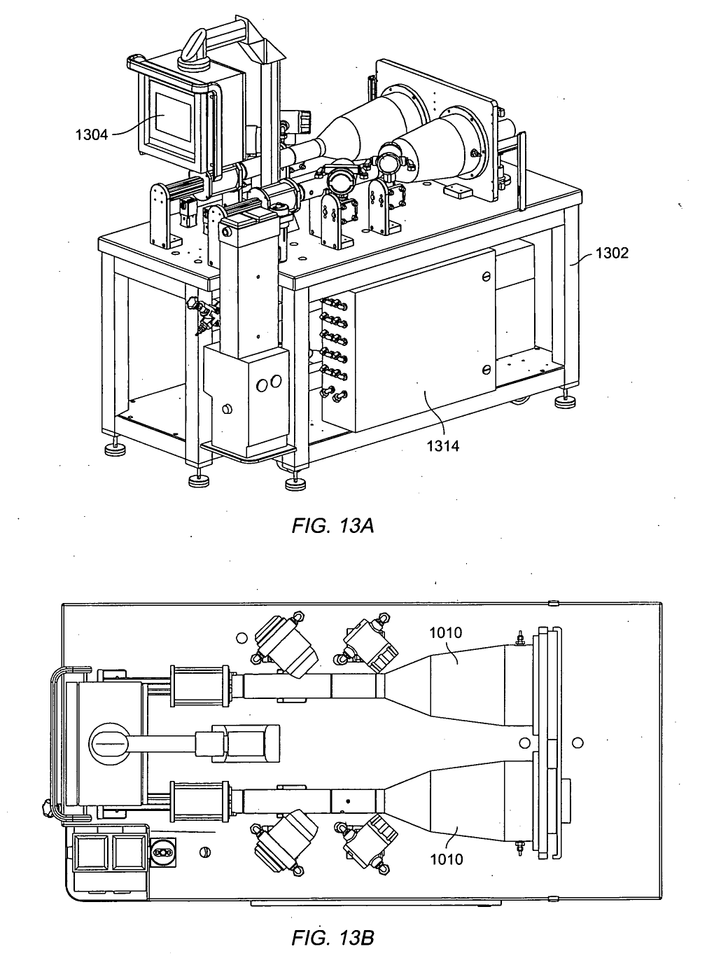

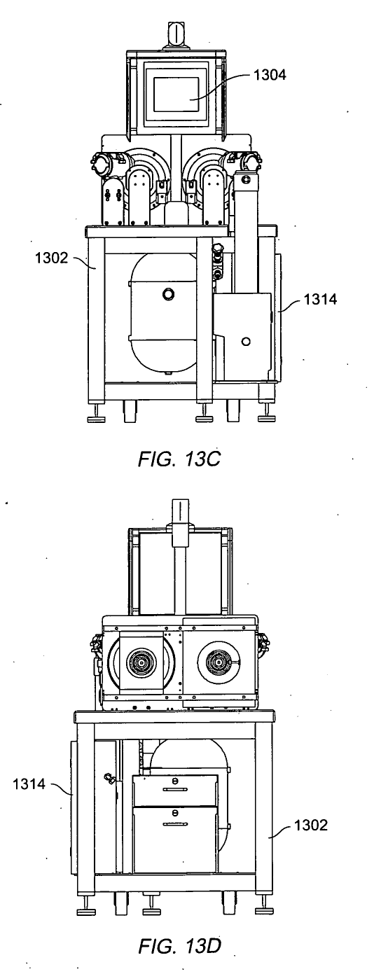

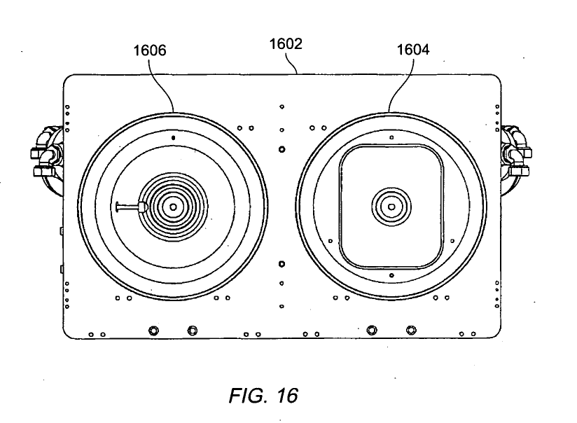

An exemplary flow testing system assembly can also be configured in various other arrangements. For example, in accordance with another exemplary embodiment, with reference to FIGS. 13A-D and FIG. 14, an exemplary flow testing system assembly can be configured without a conveyor system for loading by a robotics device, but rather through manual coupling of fluid components to output coupling subsystem. In addition, exemplary flow testing system assembly can be configured for testing differently sized or shaped fluid components in the same system. For example, with reference to FIG. 16, an exemplary coupling plate 1602 configured for dual testing operation of catalytic converters can have interface couplings 1604 and 1606 configured for different sized components. Such interface couplings 1604 and 1606 can be suitably arranged in various manners, being interchangeable with other similar or different sized interface couplings. As a result, an exemplary flow testing assembly can be configured to provide testing of various configurations of fluid components with simple adaptation of interface couplings 1604 and/or 1606 to a desired configuration.

The flow testing assembly configurations can also be configured with other additional equipment or systems to provide additional functions. For example, labeling, bar coding, tracing and other identification systems can be suitably coupled to, or configured within, an exemplary flow testing assembly. Moreover, other steps within the manufacturing process can also be suitably included within the flow testing assemblies.

The present invention has been described above with reference to an exemplary embodiment. However, changes and modifications may be made to the exemplary embodiment without departing from the scope of the present invention. For example, while the various output coupling components may be suitably configured for use with a catalytic converter, such configurations are for illustrative purposes only, and any other configurations can be suitably provided to adapt to other types of fluid flow parts and components. In addition, the various components of the flow testing system may be implemented in alternate ways depending upon the particular application or in consideration of any number of design functions associated with the operation of the system. For example, in accordance with other exemplary embodiments, an exemplary flow testing system may include a venturi subsystem coupled directly to a component test part without an output coupling subsystem. In addition, a flow amplifier can be suitably configured at the end proximate to the fluid component to suitably draw air through the flow testing system. Still further, the various flow testing assembly configurations can be provided for any number of fluid flow components at the same time, not simply one or two fluid components as is illustrated. Moreover, the various testing process steps may be suitably arranged in any order, or otherwise repeated or skipped in accordance with various other exemplary embodiments. These and other changes or modifications are intended to be included within the scope of the present invention, as set forth in the following claims.

1. A flow testing system for facilitating the continuous flow testing of fluid flow systems and components, said flow testing system comprising:
a flow amplifier subsystem configured for coupling to an air intake and for providing a controlled air flow;
a venturi subsystem configured for facilitating determination of said controlled air flow through providing of a pressure difference within;
a piping subsystem configured for coupling said flow amplifier subsystem to said venturi subsystem to receive said controlled air flow; and
an output coupling subsystem configured to couple said venturi subsystem to a fluid flow component for flow testing; and
wherein said flow testing system determines flow within the fluid flow component to determine if any defects exist within the fluid flow component.

2. The flow testing system according to claim 1, wherein said flow amplifier subsystem is coupled to the air intake through a filter valve.

3. The flow testing system according to claim 2, wherein said filter valve is configured to provide a seal for said flow amplifier subsystem during self-testing of said flow testing system.

4. The flow testing system according to claim 1, wherein said flow amplifier subsystem is configured to receive air from an air intake source of between approximately 80-100 PSI and a flow level between approximately 5-100 SCFM.

5. The flow testing system according to claim 1, wherein said flow amplifier subsystem is configured to convert air from the air intake source to a controlled air flow of between approximately 1-3 PSI and a flow level between approximately 75-1000 SCFM.

6. The flow testing system according to claim 1, wherein said flow amplifier subsystem comprises:
a flow amplifier configured for coupling to an air intake and for providing a controlled air flow;
a seal test device coupled to said flow amplifier and configured for providing a compliance seal to said flow amplifier to facilitate self-testing of said flow testing system;
a proportional regulator configured to regulate operation of said seal test device; and
a check valve coupled between said seal test device and said proportional regulator to prevent air from flowing from said seal test device back to said proportional regulator.

7. The flow testing system according to claim 1, wherein said piping subsystem comprises a passageway and an output connection configured for providing measurements of one of temperature and barometric pressure to facilitate mass-flow calculations.

8. The flow testing system according to claim 7, wherein said piping subsystem further comprises a resistance temperature detector for providing temperature compensation during determination of said mass-flow calculations.

9. The flow testing system according to claim 1, wherein said venturi subsystem comprises:
a venturi component configured to facilitate measurement of said pressure difference, said venturi component having an entry output port and an exit output port; and
a pressure difference flow device coupled to said entry output port and an exit output port to measure said pressure difference to facilitate flow calculations.

10. The flow testing system according to claim 9, wherein said venturi and said pressure difference flow device are configured in a controlled feedback loop with said flow amplifier subsystem to facilitate said controlled air flow.

11. The flow testing system according to claim 9, wherein said pressure difference flow device is configured to receive a compensation signal to compensate for one of temperature and barometric pressure when determining said pressure difference to facilitate mass-flow calculations.

12. The flow testing system according to claim 9, wherein said pressure difference flow device comprises an output signal indicative of said pressure difference to facilitate flow calculations.

13. The flow testing system according to claim 1, wherein said venturi subsystem comprises one of a venturi, restrictor plate, orifice plate and a sonic nozzle.

14. The flow testing system according to claim 1, wherein said output coupling subsystem comprises a coupling component for coupling to the fluid flow component.

15. The flow testing system according to claim 14, wherein said coupling component comprises a seal nest having a plurality of adapter plates and a plurality of sealing rings configured for providing a seal around the fluid flow component and to grip the fluid flow component.

16. The flow testing system according to claim 1, wherein said output coupling subsystem system is configured for facilitating measurements of pressure differences between an entry side and an exit side of the fluid flow component.

17. The flow testing system according to claim 1, wherein said flow testing system further comprises an automated positioning system configured for coupling said output coupling subsystem to the fluid flow component, said automated positioning system comprising a gripper device for gripping the fluid flow component, and a robot device for moving the fluid flow component.

18. The flow testing system according to claim 1, wherein said output coupling subsystem comprises an end cap configuration for facilitating self-testing of said flow testing system.

19. The flow testing system according to claim 1, wherein said output coupling subsystem comprises an output device having an output port, and a pressure difference flow device having a first input port coupled to said output port of said output device for measurement of pressure within said output device, said pressure difference flow device having a second input port configured to measure ambient pressure.

20. The flow testing system according to claim 19, wherein said pressure difference flow device configured to measure differences in pressure of between said first input port and said second input port to facilitate mass-flow calculations for flow through the fluid component.

21. The flow testing system according to claim 20, wherein said flow testing system further comprises a control system configured for control of said flow testing system, said control system is coupled to said flow amplifier subsystem, said venturi subsystem and said output coupling subsystem to control operation of said flow testing system.

22. A method for providing continuous flow testing of fluid flow systems and components, said method comprising the steps of:
establishing a controlled air flow in a flow amplifier through a venturi configured in a closed-loop system;
measuring flow within a fluid flow component, and
determining if a defect exists in said fluid flow component.

23. The method according to claim 22, wherein said step of establishing a controlled air flow occurs after connecting said fluid flow component to an output coupling subsystem.

24. The method according to claim 22, wherein said step of establishing a controlled air flow occurs before connecting said fluid flow component to an output coupling subsystem.

25. The method according to claim 22, wherein said step of establishing a controlled air flow in a flow amplifier comprises receiving air from an air intake source of between approximately 80-100 PSI and a flow level between approximately 5-40 SCFM.

26. The method according to claim 22, wherein said step of establishing a controlled air flow in a flow amplifier comprises converting air from the air intake source to a controlled air flow of between approximately 1-3 PSI and a flow level between approximately 75-600 SCFM.

27. The method according to claim 22, wherein said step of establishing a controlled air flow comprises measuring differences in pressure within an entry port and an exit port of said venturi and calculating flow within said flow amplifier.

28. The method according to claim 27, wherein said step of measuring differences in said pressure comprises measuring said pressure with a pressure difference flow device coupled to said entry port and said exit port of said venturi.

29. The method according to claim 22, wherein said step of measuring differences in said pressure comprises compensating for one of a temperature and a barometric pressure to facilitate mass-flow calculations.

30. The method according to claim 22, wherein said step of measuring flow within the said fluid component comprises measuring differences in pressure within an entry side and an exit side of said fluid component and calculating flow within said fluid component.
